(19) United States
(12) Patent Application Publication
(10) Pub. No.: US 2022/0020049 A1
(43) Pub. Date: Jan. 20, 2022

(54) ARTIFICIAL INTELLIGENCE (AI) BASED PAYMENTS PROCESSOR

(71) Applicant: ACCENTURE GLOBAL SOLUTIONS LIMITED, Dublin (IE)

(72) Inventors: Srikanth G. Rao, Bangalore (IN); Tarun Singhal, Bangalore (IN); Arunabh Sinha, Bangalore (IN); Rajeev Divakaran Nair, Bangalore (IN); Preetham Prabhu, Bangalore (IN); Mathangi Sandilya, Bangalore (IN); Madhulita Mandal, Bangalore (IN); Jayaprakash Nooji Shekar, Bangalore (IN); Anshul Tyagi, Ghaziabad (IN); T. Balakrishnan, Tiruppur (IN)

(73) Assignee: ACCENTURE GLOBAL SOLUTIONS LIMITED, Dublin (IE)

(21) Appl. No.: 16/928,764

(22) Filed: Jul. 14, 2020

(51) Int. Cl. G06Q 30/02; G06Q 20/12; G06F 40/20; G06N 5/00

(52) U.S. Cl. CPC G06Q 30/0224; G06Q 30/0239; G06N 5/003; G06F 40/20; G06Q 20/12

(57) ABSTRACT

An Artificial Intelligence (AI) based payments processing system analyzes data from a user's purchase invoice to identify a combination of payment modes to be used to pay for the user's purchases thereby maximizing the savings to the user while accounting for the user preferences. A savings oriented model including a mix and match model and a dynamic decision tree scoring model generates a savings based best offer suggesting the payment modes to be used by analyzing the user's purchases based on the offers associated with the purchased products. A user behavior model generates a user behavior based best offer by further accounting for user preferences. Based on the user's autopay settings, the payments processing system may automatically initiate payment for the user's purchases or may display the best offers to the user before initiating the payments.

### BACKGROUND

The development of the internet has led to many goods and service providers offering their products and services online for sale. As a result, the field of online payments has developed rapidly wherein an internet-based user account is associated with a monetary source such as a bank account or a private account that is replenished with funds. Many merchants now extend various offers for online purchase transactions where goods and services can be researched and purchased. The online transactions are not only convenient to the user but are also cost-effective for the merchant as retail outlets need not be maintained. Users may pay for their online purchases using various payment modes or payment mechanisms such as credit cards, debit cards, online bank transactions, mobile payment platforms, etc. Accordingly, when purchasing a product, the user may not be aware of the most optimal payment modes that, if used, for the purchase transaction would provide the maximum benefit not only on monetary terms but also in terms of the user's preferences.

### BRIEF DESCRIPTION OF DRAWINGS

Features of the present disclosure are illustrated by way of examples shown in the following figures. In the following figures, like numerals indicate like elements, in which:

FIG. 1 shows a block diagram of an AI-based payments processing system in accordance with the examples disclosed herein.

FIG. 2 shows a block diagram of a smart wallet router in accordance with the examples disclosed herein.

FIG. 3 shows a block diagram of a results processor in accordance with the examples disclosed herein.

FIG. 4 shows a flowchart that details a method of processing payments for a user's purchase in accordance with examples disclosed herein.

FIG. 5 shows a flowchart that details a method of training the user behavior model to generate the user behavior based best offer in accordance with the examples disclosed herein.

FIG. 6 shows a flowchart that details a method of generating user behavior based best offer in accordance with the examples disclosed herein.

FIG. 7A shows a flowchart that details a method of generating the savings based best offer in accordance with the examples disclosed herein.

FIG. 7B shows a flowchart that details a method of generating the savings based best offers that correspond to the total amounts in accordance with the examples disclosed herein.

FIG. 7C shows a flowchart that details a method of generating the savings based best offers that correspond to the split amounts in accordance with the examples disclosed herein.

FIG. 8 shows an example training data set in accordance with the examples disclosed herein.

FIG. 9 shows two examples best offers that are generated by the payments processing system and displayed to the user in accordance with the examples disclosed herein.

FIG. 10A shows a schematic diagram wherein a combination of the payment modes is obtained to generate a product-wise savings based best offer in accordance with the examples disclosed herein.

FIG. 10B shows another schematic diagram that shows the generation of savings based best offers that correspond to split amounts in accordance with the examples disclosed herein.

FIG. 11 shows some user interfaces (UIs) employed by the payments processing system to communicate with a user in accordance with the examples disclosed herein.

FIG. 12 shows additional UIs generated in accordance with the examples disclosed herein.

FIG. 13 illustrates a computer system that may be used to implement the payments processing system.

### DETAILED DESCRIPTION

For simplicity and illustrative purposes, the present disclosure is described by referring to examples thereof. In the following description, numerous specific details are set forth in order to provide a thorough understanding of the present disclosure. It will be readily apparent however that the present disclosure may be practiced without limitation to these specific details. In other instances, some methods and structures have not been described in detail so as not to unnecessarily obscure the present disclosure. Throughout the present disclosure, the terms “a” and “an” are intended to denote at least one of a particular element. As used herein, the term “includes” means includes but not limited to, the term “including” means including but not limited to. The term “based on” means based at least in part on.

An Artificial Intelligence (AI) based payments processing system that analyzes invoice data including products and/or services for purchase and enables payments for the purchase via payment modes that are selected to optimize for savings and user preferences is disclosed. An invoice which is generated during a purchase transaction including the details regarding the products to be purchased such as the product identifiers, the cost of each of the products, the merchant selling the products, etc., is transmitted to the payments processing system prior to the completion of the purchase transaction. The payments processing system extracts the metadata from the invoice including details of the user's purchase. The invoice metadata can include the date/time of generation of the invoice, the locale of invoice generation, the merchant generating the invoice, etc. In response to receiving the invoice and extraction of the purchase details from the invoice, the payments processing system retrieves from a user profile of the user conducting the purchase transaction. Other details such as the identification details of the user, the user data also includes one or more payment modes that are used to pay for the user's purchases are also accessed. The payment modes include payment mechanisms that may be used to pay for the products and services. These payment mechanisms may include but are not limited to, credit cards, debit cards, cash cards, store gift cards, online bank accounts, mobile payment accounts, bitcoin accounts, etc. Additionally, the payments processing system accesses offer data including offers of considerations for the one or more products corresponding to the one or more payment modes wherein the considerations are received by the user in exchange for paying for the product with the corresponding payment mode as specified in the offer. The offer data is accessed from an offers entities dictionary that is built up by the payments processing system from various data sources as specified herein.

The payments processing system employs the data extracted from the invoice, the offers data, and data regarding the user's payment modes as provided by the user profile to identify at least two best offers—a savings based best offer and user behavior based best offer. Each of the best offers identifies and provides the user with a combination of payment modes that can be used to conduct the user's purchase transaction. The savings based best offer which includes the offer details such as the payment modes to be used to access the offer(s) for one or more products in the invoice, the consideration(s) to be realized by the user in accordance with the offer(s) and the amounts to be charged to each of the payment modes for the one or more products. The considerations can include monetary considerations and non-monetary considerations. The user behavior based best offer also includes the offer details as mentioned above but the offers are selected based not only on the considerations realized by the user but also on the user preferences as collected explicitly from the user at the time of registration to the payments processing system and implicitly on recording the user behavior as the user employs the payment processing system for purchase transactions over a time period.

The savings based best offer is generated by a savings oriented model that analyzes, via a scoring methodology, the invoice data, the offers, and the user profile information using a mix and match model and a dynamic decision tree structure model. The mix and match model generates different types of pairings or combinations of the products in the invoice and the different valid payment modes from the user profile. In an example, the combinations may map a product to a payment mode so that the payment mode is used to pay the total amount for that product. In an example, the mix and match model generates multiple product-payment mode combinations for one or more of the products wherein multiple payment modes can be used to pay for a product so that the total amount for the product is split between the different payment modes. If no offer associated with a payment mode exists for a specific product, then a frequently used payment mode or a default payment mode set by the user may be employed to pay for that specific product.

The different types of combinations thus generated can be evaluated based on weights assigned to the combinations. The product-payment mode combination weights reflect the considerations realized by the user and user preferences so that the product offers associated with the payment modes with greater considerations and/or more preferred by the user are weighted higher. Therefore, it can be appreciated that a product-payment mode combination for the specific product with no offers or less-preferred can likewise carry less or zero weight reflecting that no savings accrue to the user for the purchase of that specific product. The product-payment mode combinations thus generated are provided as input to the dynamic decision tree structure model which generates a path or a tree structure by further combining the different product-payment mode combinations across the different products. A cumulative score is calculated for the different paths or tree structures identified by the dynamic decision tree structure model. The product-payment mode combinations from the path with the highest score are provided as the savings based best offer to the user. The product savings model, therefore, employs a scoring based methodology to identify the best offer.

The user behavior based best offer is generated by a user behavior model that identifies the product—payment mode combinations not only based on the offers but also based on the user preferences as recorded in historical data associated with a user profile. This historical data can store information related to the prior user selections of offers, payment modes, etc. In an example, the user behavior model may be based on AI techniques such as the k Nearest Neighbor (KNN) methodology. The KNN model is trained via supervised training to identify the payment modes to be used to pay for the products included in the user's purchase transaction. Based on the training, different payment modes can be identified for different products by the user behavior model to generate the user behavior based best offer.

The payments processing system can be further configured to determine if the savings based best offer is the same as the user behavior based best offer i.e., the same payment modes are used to pay for the same products in the same proportions. If the savings based best offer is the same as the user behavior based best offer and the user has enabled an autopay option or a frictionless payment option, then payment for the user's purchase transaction is automatically enabled on the payment modes as suggested in one of the best offers. If the savings based best offer is not the same as the user behavior based best offer, then each of the best offers is presented to the user for selection. The payment for the user's purchase transaction is enabled on the payment modes specified in the best offer selected by the user. The user's selection can be recorded for updating the user profile and training.

The payments processing system as disclosed herein provides a technical solution to the problem of generating combinations of two or more datasets using different criteria. The technical solution involves not only usage of an AI-based methodology such as the kNN model to generate a weighted dataset of product-payment mode combinations but also provides for generation of enhanced combinations via a scoring methodology wherein the output of the mix and match model is fed to the dynamic decision tree structure model. Therefore, not only are the best product-payment mode combinations identified but also the best dataset of the product-payment mode combinations is identified in terms of the cumulative score calculated for each of the paths. One application of this technical improvement pertains to the field of online transactions wherein users are enabled to map their payment modes to the offers prevailing in the market based not only in terms of the offer considerations but also in terms of each user's preferences. Each payment mode brings with it a unique set of offers and promotions which the users may or may not be aware of. Furthermore, the users are also faced with the arduous task of figuring out the best possible option to make from an array of payment options. The payments processing system, therefore, provides for users, a hybrid payments platform with AI-enabled application that additionally employs scoring methodologies to allow intelligent routing of payment choosing the best payment method with maximum savings. For the merchants, the payments processing system enables, an intelligent platform with an open banking concept which allows the acceptance of payments from multi-payment modes for a single invoice, and time saver in the entire billing process.

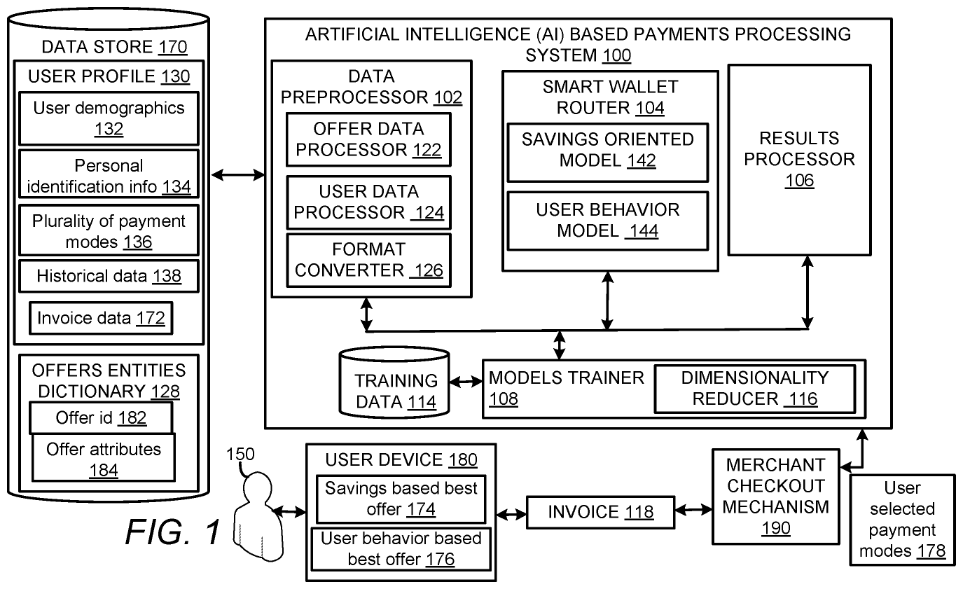

FIG. 1 shows a block diagram of the AI-based payments processing system 100 in accordance with the examples disclosed herein. The payments processing system 100 receives an invoice 118 including details regarding a user's purchases from a user device 180. The details can include a listing of one or more of the products or services purchased by the user 150 and the corresponding prices of the products. The user 150 may be purchasing the one or more products either from a brick-and-mortar store or from an online merchant. The payments processing system 100 analyzes invoice data 172 extracted from the invoice 118 to obtain offers of considerations which may be tied to specific brands, particular products, defined locations, confined to specific time periods, limited to certain purchase amounts or any other restrictions. In an example, the offers can also be associated with one or more of a plurality of payment modes 136 registered in a user profile 130. Of course, it may be appreciated that while only the plurality of payment modes 136 included in the user profile 130 are disclosed and discussed herein, the payments processing system 100 can access other payment modes which may be employed by other users to facilitate their payments in accordance with the examples disclosed herein. Based on various factors which can primarily include but are not limited to, user preferences and values of the offers, one or more of the plurality of payment modes 136 are selected for paying for the user's purchases. The plurality of payment modes 136 can include but are not limited to, debit cards, credit cards, cash cards, gift cards, mobile wallets, loyalty points accumulated via prior transactions, bank accounts with online access, or other payment modes that are accessible via open Application Programming Interfaces (APIs). In an example, the selected payment modes can be further presented to the user 150 for final selection. The user-selected payment mode(s)178 are employed to pay for the user's purchases. In an example, where the user 150 signs up for frictionless payments, automatic payments for the user purchases are enabled on the selected payment modes without further user input.

The payments processing system 100 includes a data preprocessor 102, a smart wallet router 104, and a results processor 106. Besides, a models trainer 108 is also included to train the ML models within the payments processing system 100. The data preprocessor 102 includes an offers data processor 122 and a user data processor 124. The offers data processor 122 accesses information regarding the various offers associated with different products/product categories from different manufacturers, vendors in association with entities associated with the payment modes. Each offer in the offer information can be characterized by an offer id 182 or a settlement id and the offer attributes 184 such as but not limited to the conditions for the offer (e.g., the payment mode(s) to be used, any minimum purchases needed to access the offer, any specific merchant outlets to which the offer is confined, the time limits when the offer is valid, etc. The offer information can be received via different modalities. For example, the offer information can be received by processes such as but not limited to, collecting messages, monitoring online media and emails, using web scraping techniques on the web pages, downloading from the user device 180, etc. The offer information can also be received from offline resources such as images of advertisements from print media, coupons, vouchers, third party sources, etc. Thus, the offer information can be received in different formats such as image formats, text formats, etc. The data preprocessor 102, therefore, includes a format converter 126 that converts data received in any of the image, voice, etc. formats into a standard textual format such as a plain text format. Furthermore, the offers can relate to specific payment modes and the different considerations that can be realized by the user 150 in return for using the specific payment modes. The considerations can take various forms such as price discounts on the same product or other products for the same transaction or future transactions, cashback, loyalty points, airline miles, coupons, free products or services, etc. The offers data processor 122 can use Natural Language Processing (NLP) techniques in combination with Named Entity Recognition (NER) to recognize specific offers and the entities making the offers. The text extracted from the offer information by the format converter 126 can be parsed tokenized and tagged with parts of speech (POS) data in addition to the identification of entities with NER techniques based for example, on Spacy algorithms. The offers and the entities thus extracted from the offer information can be stored in an offers entities dictionary 128. In an example, the offers data processor 122 may further include a mechanism to automatically update the offers entities dictionary 128 to delete offers that may have expired based for example, on the temporal offer attributes.

The user data processor 124 receives and processes information for building the user profile 130. When the user 150 initially signs up with the payments processing system 100 for payment mode processing, the user 150 provides information such as the user demographics 132, personal identification information 134, and the plurality of payment modes 136 that are employed to pay for the various goods and services that the user 150 may purchase. As the user 150 begins to use the payments processing system 100 for processing payments for purchases, the user's behavior and habits can be recorded by the payments processing system 100 and employed to select and recommend one or more of the offers and payment modes. Accordingly, the data preprocessor 102 receives the invoice 118 to extract the details of the user's purchases. Again, techniques such as but not limited to, NLP, NER, etc. can be employed to extract the invoice data. More specifically, invoice data 172 such as the products purchased, the quantities of the products purchased, the price of each product, the total amount, date/time/location of purchase, the vendor, etc. is extracted from the invoice 118. The invoice data 172 thus extracted can be saved to the user profile 130.

The invoice data 172 is accessed by a smart wallet router 104 which selects one or more of the plurality of payment modes 136 to pay for the user's purchases based on the offers and the user behavior. If no offers are associated with the at least one payment mode of the plurality of payment modes 136, then a default payment mode can be set up in the user profile 130 to be automatically selected for payment. The smart wallet router 104 includes two ML models, a savings oriented model 142 and a user behavior model 144, to analyze the offer information and the data in the user profile 130 with respect to the invoice data 172 to select a payment mode to pay for the user's purchases. The savings oriented model 142 analyzes the invoice data 172 and the offer information from the offer entities dictionary 128 to identify one or more of the plurality of payment modes 136 that provide maximum monetary value to the user 150 associated with the user profile 130. The monetary value can be extracted directly for considerations such as cashback, discounts, etc. However, other considerations such as miles, loyalty points, etc., may have a specific monetary value associated with each unit. For example, a mile or one loyalty point can be associated with a specific monetary value to estimate their monetary value to the user 150. The payments processing system 100 may be pre-configured to assign weightage based on different criteria to the plurality of payment modes 136. In an example, each weight can correspond to an absolute score based on different types of considerations. However, such considerations may be updated based on consumer transactions. As part of consumer demographics, the weightage of each saving type can be dynamic, wherein

weightage=Avg.(System Score+/−1) Eq. (1)

Initially, the weightage may be initialized to 1, and based on the frequency of usage of the payment mode, the weightage may be updated, provided that saving type was applicable in that transaction. For example, savings types such as post-purchase cashback on cards/wallets may have the maximum weightage while savings type such as loyalty or rewards points may have lower weightage. The savings oriented model 142 therefore may select one or more of the plurality of payment modes 136 to pay for the user's purchases based on the maximum monetary value. In an example, a corresponding payment mode of the plurality of payment modes 136 can be selected by the savings oriented model 142 for each product so that the price for that product is paid entirely by the selected payment mode. In an example, a given product can be paid for by multiple payment modes of the plurality of payment modes 136. A savings based best offer 174 including the offer details, the payment modes to be used and the amounts to be charged to each of the payment modes in response to the invoice 118 is thus generated by the savings oriented model 142.

The user behavior model 144 also analyzes the invoice data 172, the offer information (which was accessed by the savings oriented model 142) given the user behavior data, i.e., the historical data 138 to select the payment modes that may be preferred by the user 150 based on historical data included in the user profile 130. In addition to the information provided by the user 150, the payments processing system 100 also records the user's selections of offers, payment modes, purchase habits, etc. as the historical data 138 within the user profile 130. The historical data 138 provides different weighting factors based on preferences gleaned from user behavior. For example, each of the plurality of payment modes 136 can be associated with a corresponding weight which can be set proportional to the frequency with which the user employs the particular payment mode for payments. Also, the user's 150 product preferences can be used to weight the offers so that offers for the user's preferred products on the user's preferred or most frequently used payment mode carry greater weight as opposed to offers to less preferred products on less frequently used payment modes. A user behavior based best offer 176 including the offer details, the payment modes to be used and the amounts to be charged to each of the payment modes in response to the invoice 118 is thus generated by the user behavior model 144.

The smart wallet router 104 may, therefore, output two results—each result corresponding to a scoring model and machine learning (ML) models. A results processor 106 accesses and compares the savings based best offer 174 and the user behavior based best offer 176. If both the results are the same, then the results processor 106 can determine from the user profile 130, if the user has opted for frictionless payment. If frictionless payment option is activated by the user in the user profile 130, then the payment modes from one of the savings based best offer 174 and the user behavior based best offer 176 are provided as the user-selected payment modes 178 to a merchant checkout mechanism 190 to pay automatically or trigger payments for the user purchases. If the user 150 is making purchases at a brick and mortar outlet, the merchant checkout mechanism 190 can include a checkout counter. If the user 150 is making purchases at an online outlet via the internet, the merchant checkout mechanism 190 can include an online cart that enables collecting and paying for the user's purchase. If the savings based best offer 174 differs from the user behavior based best offer 176, then both the results are provided to the results processor 106 for presentation to the user 150. The user's purchases are paid for using the payment modes in one of the savings based best offer 174 and the user behavior based best offer 176 based on the user-selected payment modes 178. The user selected payment modes 178 are provided to the merchant checkout mechanism to pay for the user's purchase. In an example, the user's selection can be fed back to update the user profile 130.

A models trainer 108 employs training data 114 to train the savings oriented model 142 and the user behavior model 144 to generate the results using supervised learning. The training data 114 can include details of various users such as the users' personal identification information, the various transaction metadata of the users such as the transactions dates/time/locations, the merchant associated with the transactions, the invoiced amounts, the settlement amounts (i.e., the considerations), types of considerations associated with each offer, the offers selected by the users, etc. In an example, the models trainer 108 can include a dimensionality reducer 116 which employs techniques such as principal component analysis to execute a dimensionality reduction process that removes from the training data 114, unwanted features which do not critically impact features for prediction. The principal component analysis works by way of establishing a correlation/covariance matrix between features to pare down the initial raw data to generate the training data 114 to be used for training the user behavior model 144.

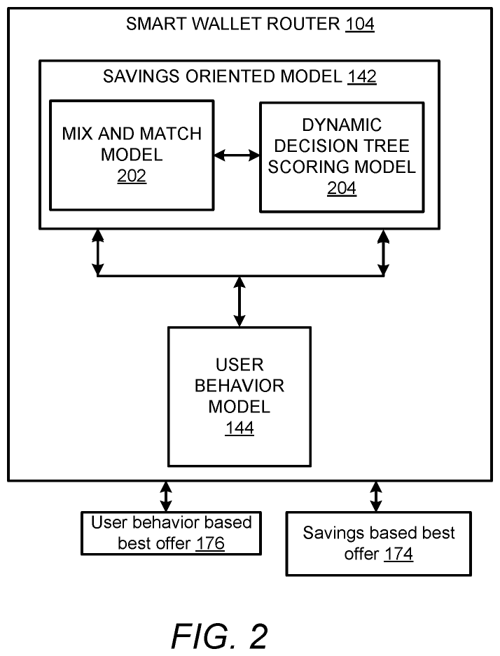

FIG. 2 shows a block diagram of the smart wallet router 104 in accordance with the examples disclosed herein. The smart wallet router 104 analyzes the offer data and the data from the user profile 130 using scoring-based techniques employed in the savings oriented model 142 as well as ML-based techniques employed by the user behavior model 144. The savings oriented model 142 analyzes information from the offers entities dictionary 128 in view of the plurality of payment modes 136 and other data in the user profile 130 to select the savings based best offer 174. The user behavior model 144 analyzes offer information from the offers entities dictionary 128 in view of the user preferences as recorded in the historical data 138 to determine the user behavior based best offer 176.

The savings oriented model 142 uses attributes such as but not limited to the user demographics, the merchant demographics, the invoice data 172 to generate the savings based best offer 174. The savings oriented model 142 includes a mix and match model 202 and a dynamic decision tree scoring model 204. The results from the mix and match model 202 are further processed by the dynamic decision tree scoring model 204 to generate the savings based best offer 174. The mix and match model 202 uses data wrangling techniques to organize the information from the offers entities dictionary 128 so that an ascending or descending order of usage is determined for the plurality of payment modes 136 to pay for a given product in the invoice 118. The order for the plurality of payment modes 136 can be determined based on the monetary value of the considerations offered in response to using the corresponding payment mode to pay for the product. For each product in the invoice 118, a weight can thus be assigned to a product-payment mode combination. If the invoice 118 includes more than one product, similar orders of usage are determined for the plurality of payment modes to pay for each of the products by the mix and match model 202.

The output from the mix and match model 202 is accessed by the dynamic decision tree scoring model 204 which determines various paths that include different product-payment mode combinations wherein the payment modes are to be used to pay for the products in entirety in one example. In another example, the paths can include different product-payment mode combinations wherein multiple payment modes can be used to pay for one product. The product-payment mode combinations can be weighted based on different factors such as but not limited to, past user behavior e.g., the user's frequency of usage of the products/payment modes, the accessibility of the payment modes, the existence of offers associated with the payment modes, the amount of consideration associated with the offers, etc. The paths may be selected and cumulative scores are calculated based on the weights of the product-payment mode combinations that make up the paths. The savings based best offer 174, therefore, includes combinations of products-payment modes that are further combined into optimal paths to provide the user 150 with maximum savings.

The user behavior model 144 generates the user behavior based best offer 176 to include a combination of payment modes to be used to pay partially or completely for a given product while accounting for user preferences. The user behavior model 144 is based on k nearest neighbor (KNN) methodology. The user behavior model 144 is trained by the models trainer 108 to identify, for each product included in the invoice 118, a corresponding payment mode to be used to pay partially or entirely for the product. In an example, the user behavior model 144 is trained via supervised machine learning techniques. The data from the user profile 130 is accessed, and other users with profiles similar to the user profile 130 are identified via similarity techniques such as cosine similarity, etc. The similarity is determined based on three factors which can include the users, the payment modes, and the products.

In an example, wherein the user 150 signs up as a new user to use the payments processing system 100, sufficient historical data may not be initially available for the user behavior model 144. In such instances, only the savings based best offer 174 is employed to enable payment for the invoice 118. As the user 150 continues to use the payments processing system 100, the user's preferences are recorded in the historical data 138. The historical data 138 thus built up can be employed by the user behavior model 144 to identify similar users via the kNN methodology. Based on the selections of one or more of the payment modes and the offers made by the similar users, payment modes/offers may be suggested to the user 150 in the user behavior based best offer 176.

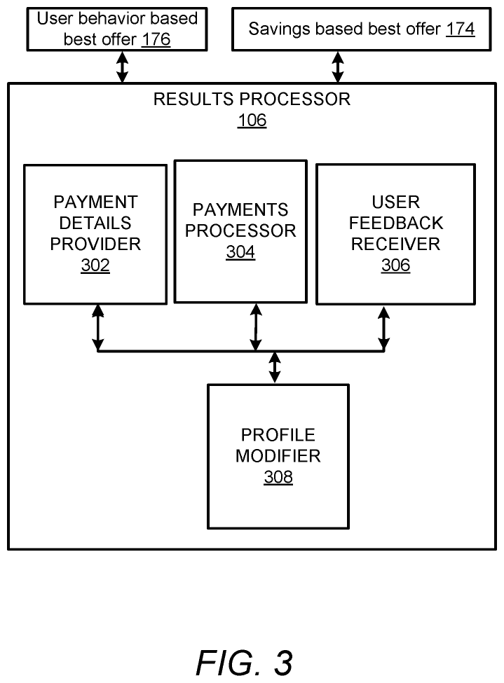

FIG. 3 shows a block diagram of the results processor 106 in accordance with the examples disclosed herein. The results processor 106 includes a payment details provider 302, a payments processor 304, a user feedback receiver 306, and a profile modifier 308. The payment details provider 302 access and compares the savings based best offer 174 and the user behavior based best offer 176. If it is determined that the savings based best offer 174 is the same as the user behavior based best offer 176, then the user profile 130 can be accessed to determine if the user 150 has signed up for frictionless payments. If the user has signed up for frictionless payments automatic payment for the user's purchase is initiated by the payments processor 304 on the payment mode(s) specified in one of the savings based best offer 174 or the user behavior based best offer 176.

If it is determined that the savings based best offer 174 is not same as or identical to the user behavior based best offer 176, or if it is determined that the user 150 has not signed up for frictionless payments, then the savings based best offer 174 and/or the user behavior based best offer 176 are presented to the user 150 on the user device 180 by the payment details provider 302. When the user 150 selects one of the savings based best offer 174 or the user behavior based best offer 176, the selected offer is received by the user feedback receiver 306. The user feedback receiver 306 provides the user-selected offer to the payments processor 304 and the profile modifier 308. The payments processor 304 initiates payment for the user's purchase(s) on the payment modes and in a proportion specified in the user-selected offer. The profile modifier 308 modifies the user profile 130 by recording the user's selected payment modes in the historical data 138. In addition, the user selections may also be added to the training data 114 that is used to train the ML models. Therefore, the user's current selections drive future offers and payment mode options that are provided to the user 150.

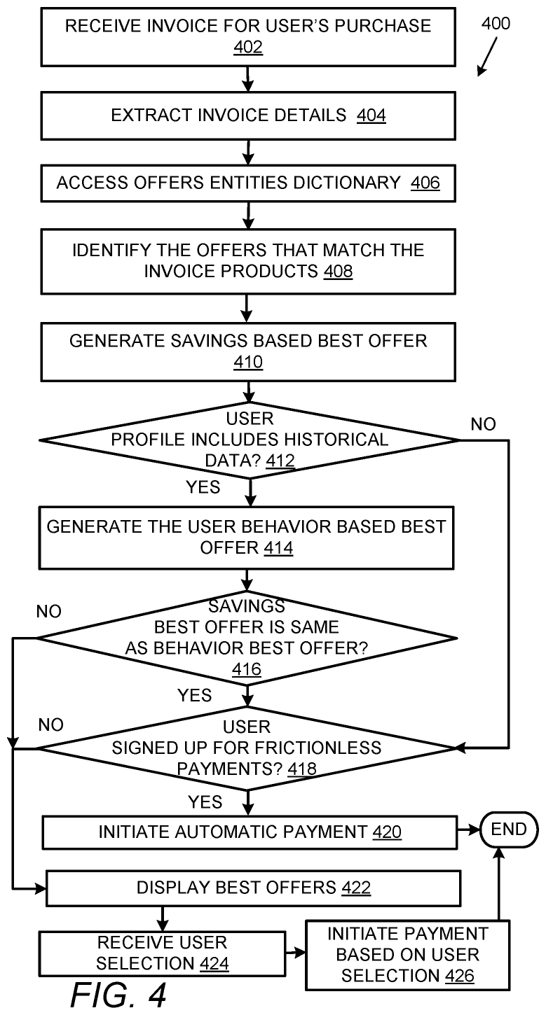

FIG. 4 shows a flowchart 400 that details a method of processing payments for a user's purchase in accordance with examples disclosed herein. The method begins at 402 with the payments processing system 100 receiving the invoice 118 associated with the user's 150 purchase. The invoice 118 includes details regarding one or more products purchased by the user 150 and the prices of the products. The data including the user's 150 purchase details are extracted from the invoice 118 at 404. The offers entities dictionary 128 is accessed at 406 and the offers that match the products in the invoice 118 are identified at 408 by the user data processor 124. In an example, the user data processor 124 can employ NLP techniques such as but not limited to tokenizing, parsing and NER to identify the offers that match the user's purchases as extracted from the invoice 118. In an example, the offers include specific considerations tied to the usage of the plurality of payment modes 136 to pay for the user's purchase. At 410, one or more of the plurality of payment modes 136 are selected the savings oriented model 142 to generate the savings based best offer 174 using a scoring based methodology. As mentioned herein, the offers can include monetary considerations such as direct price discounts on the current purchase transaction, cashback, discounts on future purchases, etc., and non-monetary considerations such as miles, loyalty points, free goods or services, etc. When comparing the offers to select the best savings based best offer 174, the non-monetary considerations can be converted into the corresponding monetary values to be compared to the monetary considerations.

At 412 it is determined if the user profile 130 includes historical data 138 regarding the prior purchases and payment mode selections of the user 150. If it is determined at 412 that there is no accumulated historical data regarding the user 150, the method proceeds to 420 to determine if the user has signed up for frictionless payments. If it is determined at 420 that the user 150 has signed up for frictionless payments, then the payment for the user's purchase is automatically initiated at 416 on the payment modes selected by the savings based best offer 174.

If it is determined at 412 that the user profile 130 includes the historical data 138, the method proceeds to 414 to employ the user behavior model 144 to generate the user behavior based best offer 176 wherein one or more of the plurality of payment modes 136 are selected to pay for the user's purchases, based not only on the considerations associated with the offers corresponding to one or more of the plurality of payment modes 136, but also based on prior user preferences as included in the historical data 138. As mentioned above, the user behavior model 144 is trained to employ data from the user profile 130 in order to identify other users of the payments processing system 100 with similar profiles by employing methodologies such as kNN methodology. The user behavior model 144, therefore, predicts that payment modes that would be preferred by the user 150 to pay for each of the products in the invoice 118 based on payment mode and offer preferences of the other users with similar profiles. Taking into account the user preferences enables the payments processing system 100 to allow for the possibility of certain user preferences superseding the monetary value of the offers. For example, an offer for a free food item may be rated highest by the savings oriented model 142 based on the monetary value. However, when the user preferences indicate that the user 150 does not consume such food product, then the offer for the food item is given lower value by the user behavior model 144. The payments processing system 100, therefore generates two offers—the savings based best offer 174 and the user behavior based best offer corresponding to the two different models.

Accordingly, at 416, it is further determined if the savings based best offer 174 and the user behavior based best offer 176 are identical in that each of the offers includes the same payment mode to be used to pay for each product for the same amount. If it is determined at 416 that the savings based best offer 174 and the user behavior based best offer 176 are identical, then it is further determined at 418 if the user has signed up for frictionless payments. If it is determined at 418 that the user 150 has signed up for frictionless payments, then payment for the user's purchase is automatically initiated at 420 on the payment modes selected by the savings based best offer 174.

If at 416 it is determined that the savings based best offer 174 and the user behavior based best offer 176 are not identical or if it is determined at 420 that the user has not signed up for frictionless payments, then one or more of the savings based best offer 174 and the user behavior based best offer 176 are displayed to the user 150 at 422 for selection. The best offer selected by the user 150 is received at 424 and the payment for the user purchase is initiated at 426 based on the user-selected payment modes 178 included in the user-selected best offer. In an example, the payments processing system 100 may also display the user-selected payment modes 178 on the merchant checkout mechanism 190 to update the merchant regarding the payment modes for the purchase.

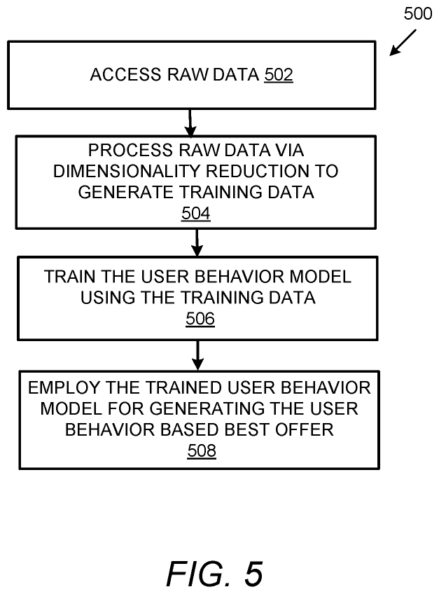

FIG. 5 shows a flowchart 500 that details a method of training the user behavior model 144 to generate the user behavior based best offer 176 in accordance with the examples disclosed herein. The method begins at 502 wherein the raw data to be used for training the user behavior model 144 is accessed. As the user behavior model 144 needs to be trained for identifying a confluence of user preferences, existing offers, the plurality of payment modes 136 and the products in the invoice 118, the raw data includes attributes associated with the historical preferences of users such as the products purchased by the users, the different payment modes used to pay for their purchases and the offers that were received and used for the purchases, etc. The training data 114 may include various attributes of the aforementioned entity data sets. However, while some of the attributes may be useful for training the user behavior model 144, other attributes may not be necessary. Therefore, the initial raw datasets are processed for dimensionality reduction at 504. The user behavior model 144 based on the kNN methodology is trained at 506 using the training data 114. The user behavior model 144 thus trained is employed at 508 to generate the user behavior based best offer 176 at 508.

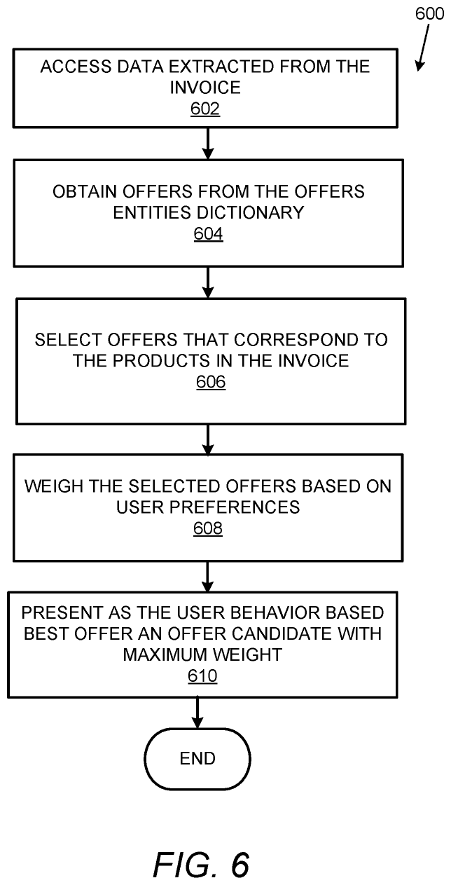

FIG. 6 shows a flowchart 600 that details a method of generating the user behavior based best offer in accordance with the examples disclosed herein. The method begins at 602 wherein the data extracted from the invoice 118 is accessed. The offers entities dictionary 128 is accessed at 604 to obtain information regarding the offers that exist for products included in the invoice 118. As mentioned above, each of the offers can include an offer id, the offer attributes which can further include the consideration associated with each offer, and the payment modes, if any, that may be specified for each of the offers. The user profile 130 is accessed at 606 and the products, the offers for one or more of the products, and the payment modes associated with the offers which may be present in the user profile 130 are accessed. In particular, the offers that correspond to one or more of the products in the invoice 118 are selected at 606. The selected offers are weighed at 608 based on the user product and/or payment mode preferences as recorded in the historical data 138 to produce offer candidates. For example, when the user 150 initially signs up to use the payments processing system 100 the administrative user may set equal weights for all the plurality of payment modes 136. As the user 150 continues to use the payments processing system 100, the weights may be increased or decreased based on the frequency with which user 150 employs the payment modes to pay for purchases. The offer candidates with maximum weight is presented to the user 150 as the user behavior based best offer 176. The user behavior based best offer 176 includes the various considerations corresponding to the offers for one or more products corresponding where the corresponding payment modes are used to pay for the products.

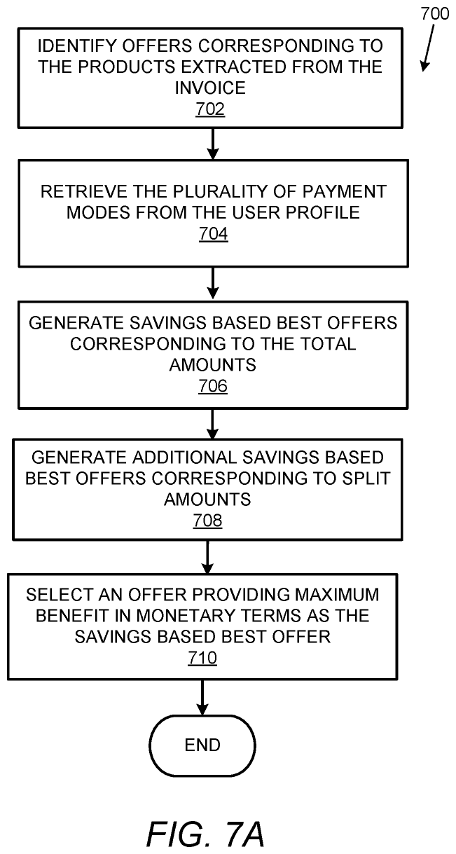

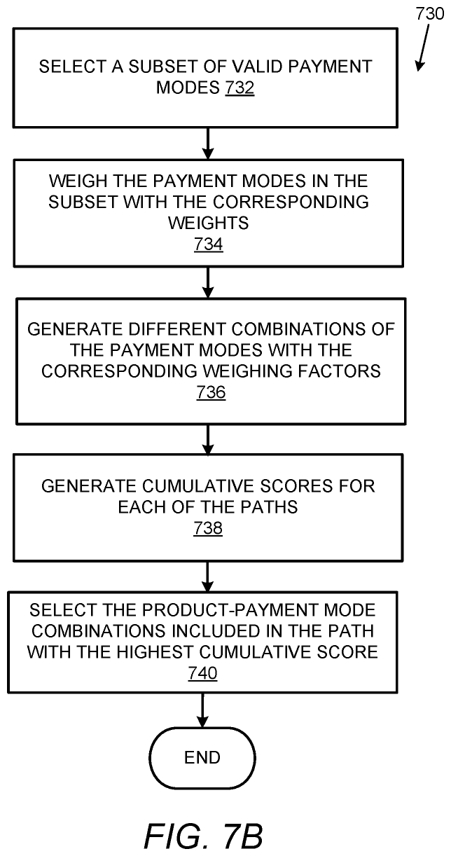

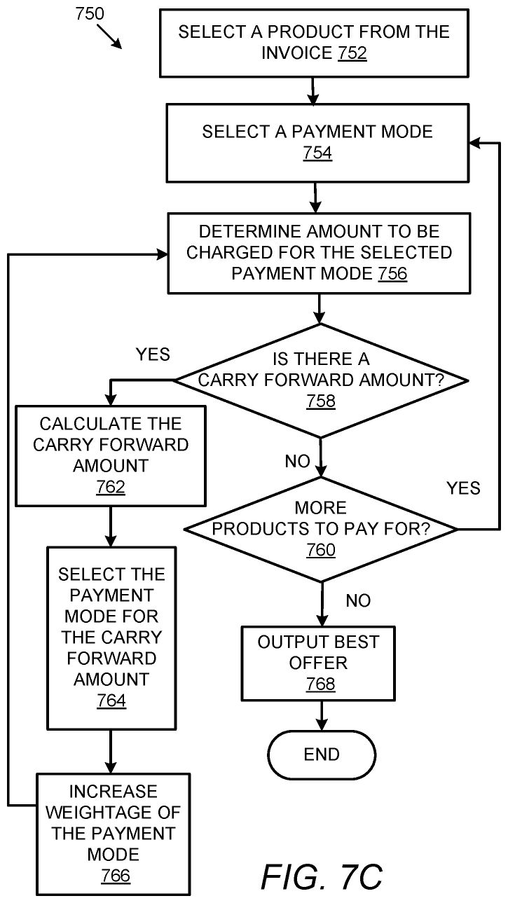

FIG. 7A shows a flowchart 700 that details a method of generating the savings based best offer in accordance with the examples disclosed herein. The method begins at 702 wherein the offers entities dictionary 128 is accessed and the offers corresponding to the products extracted from the invoice 118 are identified. The plurality of payment modes 136 is retrieved from the user profile at 704. At 706, one or more savings based best offers that correspond to total amounts are generated wherein the entire amount for each product on offer is charged to one payment mode, or a single payment mode is used to pay for each of the products on offer. At 708, one or more additional savings based best offers that correspond to split amounts are generated wherein multiple payment modes can be used to pay for one product. At 710, the best offer that provides maximum consideration or benefit in monetary terms to the user 150 is selected from the savings based best offers that correspond to total amounts and the additional savings based best offers that correspond to split amounts. In an example, the top three offers can be identified from the total amount offers and the split amount offers and the offer providing the maximum monetary value can be further selected.

It may be noted that in generating the user behavior based best offer 176 or the savings based best offer 174, if multiple offers become eligible for selection as the corresponding best offers, then multiple offers may be presented to the user as the best offers.

FIG. 7B shows a flowchart 730 that details a method of generating the savings based best offers that correspond to the total amounts in accordance with the examples disclosed herein. The method begins at 732 wherein a subset of valid payment modes which include one or more of the plurality of payment modes 136 that can be used for payments are selected. At 734 each of the payment modes in the subset of payment modes is associated with a corresponding weighting factor. The weighting factors may be set automatically based on the monetary value of the offer corresponding to the payment mode so that the payment mode associated with the offer having a maximum consideration is weighed higher than a payment mode associated with a lower monetary value offer. The payment modes which are invalid and cannot be used for payments may be discarded from consideration by setting their weighing factor to zero. At 736 different combinations of the products and the payment modes with the corresponding weighting factors are generated by the mix and match model 202 wherein the same payment mode or different payment modes can be employed to pay the full amount for each of the products. At 738, a cumulative score is generated for each path including combinations of products and the corresponding payment modes by the dynamic decision tree scoring model 204. The path with the highest cumulative score can be selected as the savings based best offer that corresponds to the total amounts at 740.

FIG. 7C shows a flowchart 750 that details a method of generating the savings based best offers that correspond to the split amounts in accordance with the examples disclosed herein. The method begins at 752 wherein a product from the invoice is selected based on the offers information from the offers entities dictionary 128. One of the plurality of payment modes 136 is selected at 754. At 756, the amount to be charged to the selected payment mode is determined. It is further determined at 758 if there is a carry forward amount for the product that needs to be charged to another payment mode. The carryforward amount may be determined based on minimum offer condition and absolute discount available for the product in the offers entities dictionary 128. In an example, the carry-forward amount may also depend on the availability of one or more of the plurality of payment modes 136 for the carry forward payments.

If it is determined at 758 that there is no carry forward amount to be charged to a next payment mode, it is further determined at 760 if there are more products to be paid for. If it is determined at 760 that there are further products to be paid for, the method returns to 752 to select the product. If it is determined at 760 that there are no more products to be paid for, the method terminates on the end block.

If it is determined at 758 that there is a carry forward amount, the carry forward amount is calculated at 762 as described herein based on the minimum offer condition. The next payment mode to be used to pay the carry forward amount is selected at 764 and the weight for the corresponding payment mode is increased by a predetermined number at 766. This is because whenever an amount to be charged to a payment mode is split between multiple payment modes, it implies that such as split transaction realizes greater savings/gains to the user 150. It may be noted that the selection of payment mode at 764 may be rather different from the selection of the payment mode at 754 because the selection of payment mode at 764 occurs from a subset of the remaining payment modes from the plurality of payment modes 136 after the payment mode previously selected at 754 is excluded. The method returns to block 756 wherein the amount to be charged to the selected payment mode is determined. Again, it is further determined at 758 if there is a carry forward amount for the product that needs to be charged to yet another payment mode. The method may thus proceed until it is determined at 758 there is no further carry forward amount and the next product is selected at 760 for further payment. If no more products remain to be paid for, the savings based best offer that corresponds to the split amounts is output for further processing at 768 as described herein and the method terminates on the end block.

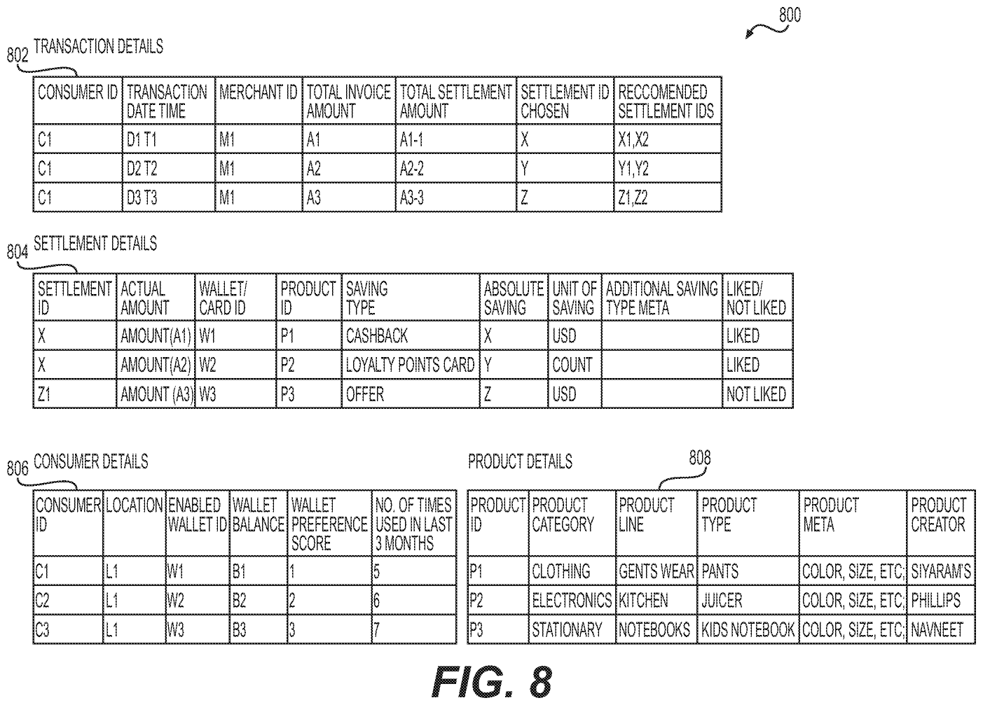

FIG. 8 shows an example training data set 800 in accordance with the examples disclosed herein. The training data 114 can include many data sets collected from various transactions conducted by users who may use different payment modes to pay for their purchases. The example training data set 800 includes transaction details 802 such as consumer IDs, transaction dates/times, merchant IDs, total invoice amounts which would be the cost of the products or services before the application of the offers (but may include discounts provided by the merchant), the total settlement amounts which include the considerations received by the users upon applying the offers to the invoice, the settlement IDs that were recommended for the transactions and the settlement IDs that was chosen by the users. The training data set 800 also includes settlement details 804 such as the settlement IDs, the actual amounts which may include the retail price of the products, the wallet/card which may correspond to the payment modes used, the product IDs, the savings types or the types of consideration offers such as cashback, loyalty points cards, offers, etc. The absolute savings represent the numerical values of the considerations, the unit or currency associated with the numerical values of the considerations, any additional savings type, and whether the settlement ID was liked or disliked. The various consumer details 806 and the product details 808 may also be included in the training data 114 to train at least the user behavior model 144. The various fields in the consumer details 806 can include the consumer ID, the Location, the enabled wallet ID which includes the payment mode selected by the user, the wallet/payment mode balance, the wallet/payment mode preference, the number of times the wallet/payment mode was used in the last 3 months, etc. The product details 808 include the product ID, the product category, the product line, the product type, the product meta, and the product creator or product manufacturer. In an example, all the fields in the details described herein may be used to train the different models. In an example, one or more of the fields may be deleted using the dimensionality reducer 116.

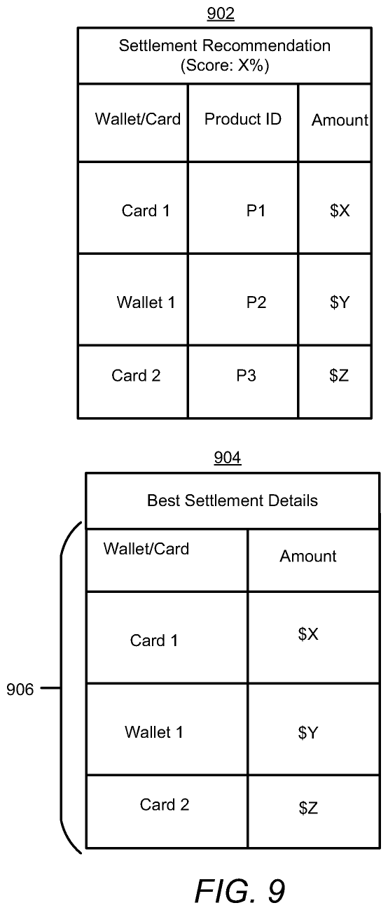

FIG. 9 shows two best offers 902 and 904 that can be generated by the payments processing system 100 and displayed to the user 150 in accordance with the examples disclosed herein. The best offer 902 is an example of the user behavior based best offer 176 generated based on the percentage match of the user profiles. The different wallets/payment modes to be used for the different products and the different amounts are shown in the best offer 902. The best offer 904 can represent an example of the savings based best offer 174 generated by the savings oriented model 142. The best offer 904 can relate to a savings based best offer corresponding to the total amount wherein each of the different payment modes 906 can be used to pay for multiple products with the total amount for each product being charged to one of the payment modes 906. The best offer 904 can also relate to a savings based best offer corresponding to a split amount for an invoice with a single product wherein each of the different payment modes 906 can be used to pay for the total amount for the product with the total amount for the product being split and partial amounts $X, $Y and $Z for the product being charged to each of the different payment modes 906.

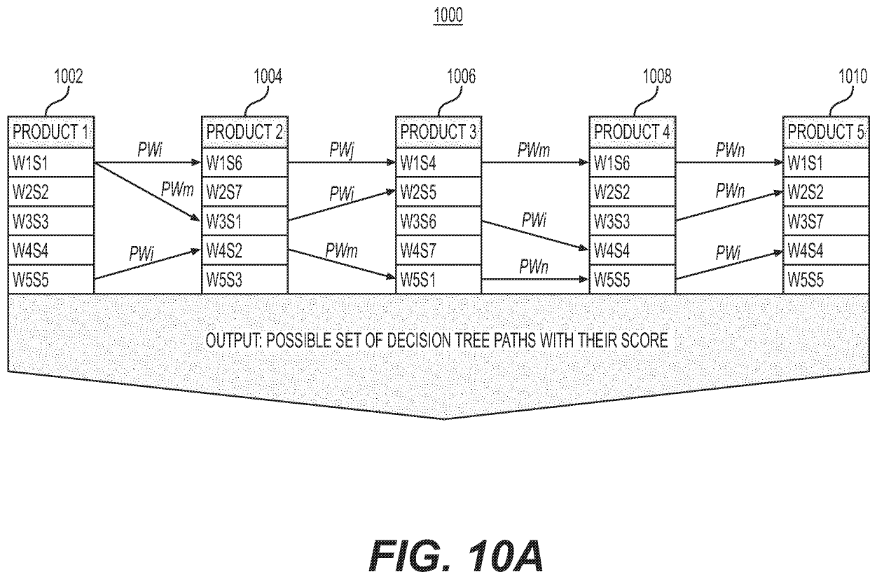

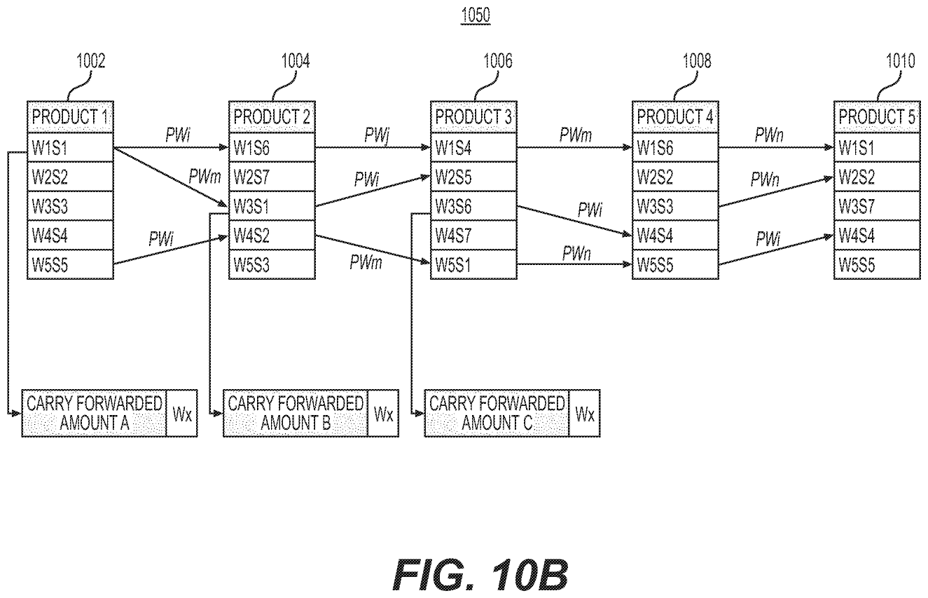

FIG. 10A shows a schematic diagram 1000 wherein a combination of the payment modes is obtained to generate product-wise savings based best offer in accordance with the examples disclosed herein. The schematic diagram 1000 shows usage of the plurality of payment modes 136 to pay for a plurality of products 1002, 1004, 1006, 1008, and 1010 extracted from the invoice 118. Each of the plurality of products 1002-1010 can be paid for using one of the payment modes W1, W2, W3, W4, and W5 retrieved from the user profile 130. Each of the payment modes W1, W2, W3, W4, and W5 is associated with a corresponding savings S1, S2, S3, S4, S5, S6, and S7 realized by the user if that payment mode is employed to pay for a product. The savings Sn can be determined based on the type and value of the considerations associated with the offers. Therefore, Sn represents the independent saving amount of type n on using the payment mode/wallet Wn and WnSn has an associated weightage that is obtained as an average of weightage of savings type, the balance (or available monies) on the wallet or payment mode raking of a percentage of savings on the total invoice among other payment modes. PWn represents weightage for the respective path. It may be noted that only valid payment modes from the plurality of payment modes 136 in the user profile 130 are employed in forming the paths or the combinations of payment modes. Valid payment modes may include the payment modes that can be used to pay for the purchases. For example, expired cash cards, or expired credit cards, etc., are deemed invalid and therefore disregarded during the path formation. The weightage WnSn value negatively impacts the weightage of the next node Wn+1Sn+1. Different combinations of WnSn (where n takes a value from 1-7) may thus be produced by the mix and match model 202 leading to different paths that are analyzed by the dynamic decision tree scoring model 204. The dynamic decision tree scoring model 204 scores the different paths by calculating a path weightage for each path. The path weightage PWn can have a 0% value representing no impact on the next step weightage and 100% if the intention is to override the weightage of the next node to zero. For example, if, after utilizing W1S1, the payment mode balance becomes zero, then that payment mode may not be used to pay for any other product. Each overall decision path starting from product 1002 to 1010, gets a cumulative score which is calculated as an aggregate of WnSn and PWn. Three different paths PWi, PWm, and PWj are shown in the schematic diagram 1000. The path PWi includes a combination of W1S1 for the product 1002, W1S6 for the product 1004, W1S4 for the product 1006, W4S4 for the product 1008 and W4S4 for the product 1010. Hence, the cumulative score of a path includes the independent savings amounts of W1 and W4 for each product and the path weightage PWi. Similarly, cumulative scores for the paths PWm and PWj are also calculated. The cumulative scores of the three paths PWi, PWm, and PWj are compared and the path with the highest cumulative score is selected as a candidate offer for further analysis and processing to be presented to the user 150.

FIG. 10B shows another schematic diagram 1050 wherein like elements are represented by like numerals used in FIG. 10A. The schematic diagram 1050 shows the payments for the products 1002-1010 being processed by the mix and match model 202 and the dynamic decision tree scoring model 204 so that the amount for one or more of the products 1002-1010 is split between the payment modes W1, W2, W3, W4, and W5 so that more than one of the payment modes W1, W2, W3, W4, and W5 can be used to pay for one of the products 1002-1010. As described above, each of the payment modes W1, W2, W3, W4, and W5 is associated with one of the corresponding savings S1, S2, S3, S4, S5, S6, and S7 wherein the savings can be determined based on a type and value of the considerations associated with the offers. The description of the formation of paths PWi, PWm, and PWj using the combinations of the payment modes is also similar as described above. However, in this instance, the payment mode W1 is not used to pay for the product 1002 fully and an amount A is carry forwarded to be paid by the next payment mode. Similarly, a carry forward amount B is generated for the product 1004 and a carry forwarded amount C is generated for the product 1006. The entire amount is paid for even as the payment for product 1008 is processed.

Carry forwarded amount is calculated based on minimum offer condition and maximum absolute discount available. For example, if the offer specifies a 10% discount or a maximum 50$ off on a minimum purchase of $300 and if the product cost is 1000$ then 10% of 1000$ is 100$. As the maximum discount is only $50, the payments processing system 100, therefore, proposes to pay only $500 using this offer so that the user avails the $50 discount. Hence the mix ‘n’ match algorithm splits the amount in this scenario so that 50% is paid by the payment mode W1 and the remaining 50% is carry forwarded to the next payment mode to optimize the savings for the user 150. Whenever there is a possibility of a split amount, the WnSn weightage gets a positive upgrade because it impacts the overall saving positively. Carry forwarded amounts are generally used for saving types such as loyalty points or cashback on a particular payment mode.

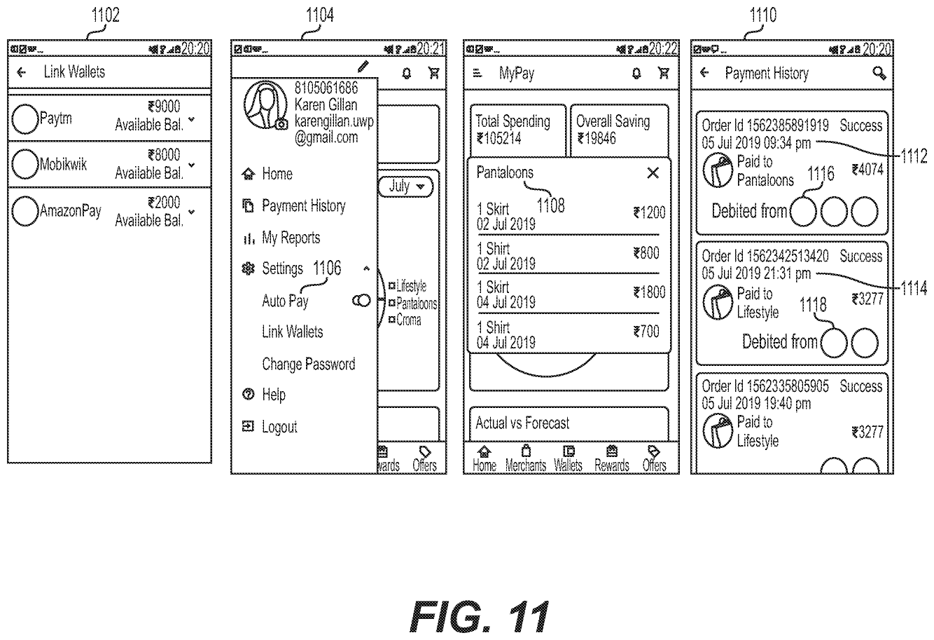

FIG. 11 shows some user interfaces (UIs)employed by the payments processing system 100 to communicate with the user 150 in accordance with the examples disclosed herein. The linked wallets interface 1102 shows the different wallets linked to the user profile in the payments processing system 100. The user profile interface 1104 shows an autopay option 1106 which is switched on by the user to opt for frictionless payments so that the payment transactions for the products are automatically executed via the payment modes identified in one of the savings based best offer 174 or the user behavior based best offer 176. The invoice interface 1108 shows the various products purchased by the user while the payment history interface 1110 shows the different payment modes employed for different transactions. For example, for the first transaction 1112, three different payment modes 1116 were used while for the second transaction 1114 two different payment modes 1118 were used.

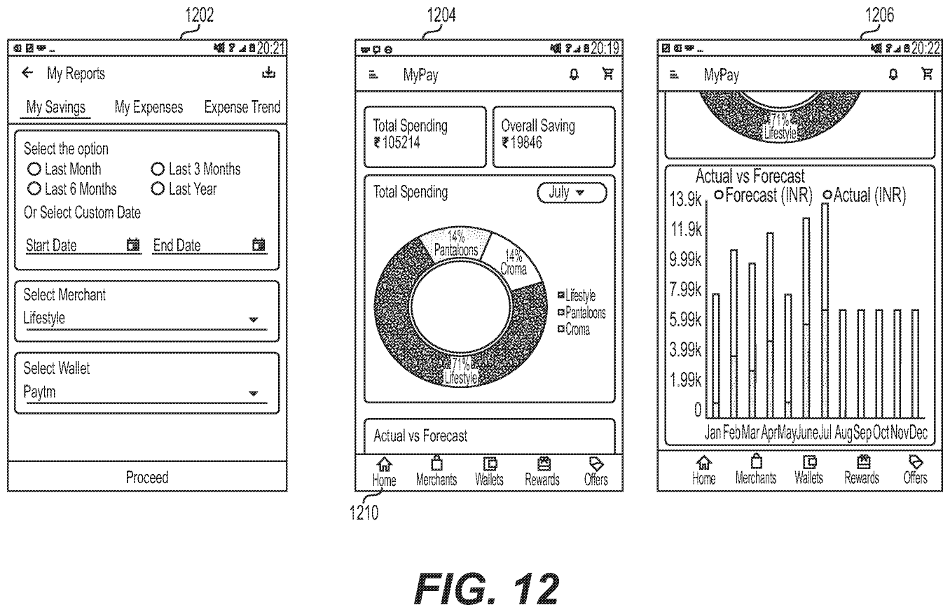

FIG. 12 shows additional UIs generated in accordance with the examples disclosed herein. The reports UI 1202 provides the user reports regarding the user's savings and expenses for a selected time period. The MyPay UI 1204 shows the user's expenses at different merchants in addition to including a forecast UI 1206 that shows an actual versus forecasted expenses. A toolbar 1210 provides the user access to different UIs including home, merchants, wallets, rewards, and offers.

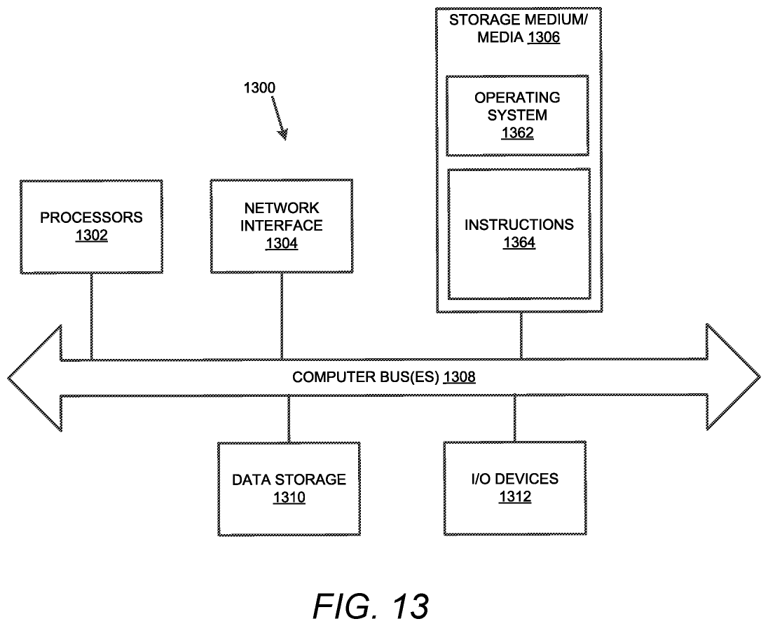

FIG. 13 illustrates a computer system 1300 that may be used to implement the payments processing system 100. More particularly, computing machines such as desktops, laptops, smartphones, tablets, and wearables which may be used to generate or access the data from the payments processing system 100 may have the structure of the computer system 1300. The computer system 1300 may include additional components not shown and that some of the process components described may be removed and/or modified. In another example, a computer system 1300 can sit on external-cloud platforms such as Amazon Web Services, AZURE® cloud or internal corporate cloud computing clusters, or organizational computing resources, etc.

The computer system 1300 includes processor(s) 1302, such as a central processing unit, ASIC or another type of processing circuit, input/output devices 1312, such as a display, mouse keyboard, etc., a network interface 1304, such as a Local Area Network (LAN), a wireless 802.11x LAN, a 3G, 4G or 5G mobile WAN or a WiMax WAN, and a processor-readable medium 1306. Each of these components may be operatively coupled to a bus 1308. The computer-readable medium 1306 may be any suitable medium that participates in providing instructions to the processor(s) 1302 for execution. For example, the processor-readable medium 1306 may be non-transitory or non-volatile medium, such as a magnetic disk or solid-state non-volatile memory or volatile medium such as RAM. The instructions or modules stored on the processor-readable medium 1306 may include machine-readable instructions 1364 executed by the processor(s) 1302 that cause the processor(s) 1302 to perform the methods and functions of the payments processing system 100.

The payments processing system 100 may be implemented as software stored on a non-transitory processor-readable medium and executed by the one or more processors 1302. For example, the processor-readable medium 1306 may store an operating system 1362, such as MAC OS, MS WINDOWS, UNIX, or LINUX, and code 1364 for the payments processing system 100. The operating system 1362 may be multi-user, multiprocessing, multitasking, multithreading, real-time and the like. For example, during runtime, the operating system 1362 is running and the code for the payments processing system 100 is executed by the processor(s) 1302.

The computer system 1300 may include a data storage 1310, which may include non-volatile data storage. The data storage 1310 stores any data used by the payments processing system 100. The data storage 1310 may be used to store the invoice 118, the data extracted from the invoice 118, the matching offers, the best offers that are generated and other data that is used by the payments processing system 100 during the course of operation.

The network interface 1304 connects the computer system 1300 to internal systems for example, via a LAN. Also, the network interface 1304 may connect the computer system 1300 to the Internet. For example, the computer system 1300 may connect to web browsers and other external applications and systems via the network interface 1304.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

What is claimed is:

1. An Artificial Intelligence (AI) based payments processing system, comprising:
at least one processor;
a non-transitory processor-readable medium storing machine-readable instructions that cause the processor to:
extract metadata from an invoice including details of a user's purchase, wherein the metadata extracted from the invoice includes at least a listing of one or more products purchased by the user and corresponding prices of the one or more products;
retrieve user data pertaining to one or more payment modes associated with a user profile, wherein the one or more payment modes are used to pay for the user's purchase;
access offer data including offers of considerations for the one or more products corresponding to the one or more payment modes, the considerations to be received by the user in response to paying for the product with the corresponding payment mode of the one or more payment modes;
identify a savings based best offer from the offers of considerations for at least one product of the one or more products, wherein the savings based best offer is identified by a savings oriented model that causes an output of a mix and match model to be processed by a dynamic decision tree structure model based on the offer data;
determine if the user profile has historical data related to prior user selections of offers and payment modes;
if the user profile includes the historical data:
identify a user behavior based best offer from the offers of considerations for the at least one product of the one or more products, wherein the user behavior based best offer is determined by a user behavior model based on the historical data from the user profile and the offer data;
and
enable payments for the user's purchase by selecting the payment modes based at least on one of the user behavior based best offer and the savings based best offer.

2. The AI-based payments processing system of claim 1, wherein to enable payments for the user's purchase the processor is to further:
determine if the user behavior based best offer is the same as the savings based best offer in terms of the considerations and the corresponding payment modes.

3. The AI-based payments processing system of claim 2, wherein the user behavior based best offer is the same as the savings based best offer and the processor is to further:
determine if the user has enabled frictionless payment option from the user profile; and
trigger automatic payment for the user's purchase using the payment modes set out in one of the user behavior based best offer and the savings based best offer if the user has enabled the frictionless payment option.

4. The AI-based payments processing system of claim 2, wherein if the user behavior based best offer is not identical to the savings based best offer, to enable payments for the user's purchase the processor is to further:
enable presentation of the user behavior based best offer and the savings based best offer for selection to the user via a user device; and
trigger payments for the user's purchase using the payment modes set out in one of the user behavior based best offer and the savings based best offer based on the user selection.

5. The AI-based payments processing system of claim 1, wherein to access the offer data, the processor is to:
retrieve web pages associated with the one or more products and merchants associated with the user purchases; and
receive data regarding the offers from third party data sources in a plurality of formats;
extract data regarding the offers from at least one of the one or more products and the merchants from the web pages using web scrapping techniques; and
convert the data in the plurality of formats to textual format.

6. The AI-based payments processing system of claim 5, wherein to access the offer data, the processor is to:
extract one or more of the considerations, the one or more products, the merchants and the payment modes by processing the data from the web pages and the data converted to textual format using natural language processing (NLP) techniques and named entity recognition (NER) techniques; and
store the considerations, the one or more products, the merchant and the payment modes obtained using the NLP and the NER techniques in an offer-entities dictionary.

7. The AI-based payments processing system of claim 1, wherein the user behavior model is based on K Nearest Neighbor (KNN) methodology.

8. The AI-based payments processing system of claim 1, wherein the mix and match model that employs data wrangling techniques.

9. The AI-based payments processing system of claim 1, wherein to identify the savings based best offer the processor is to:
output a combination of at least one valid payment mode corresponding to each product of the one or more products as the selected payment modes in the savings based best offer, wherein the at least one valid payment mode is used to pay entirely for the corresponding product.

10. The AI-based payments processing system of claim 9, wherein to output the combination the processor is to:
select, using the mix and match model, the at least one valid payment mode for the corresponding product of the one or more products based on independent savings amount associated with the at least one valid payment mode;
obtain, using the dynamic decision tree scoring model, one or more paths that combine the at least one valid payment mode corresponding to each of the one or more products;
calculate a cumulative score for each of the one or more paths by combining the independent savings amount with a path weightage; and
identify the at least one valid payment mode associated with one of the paths with a highest cumulative score from the cumulative scores as the selected payment modes in the savings based best offer.

11. The AI-based payments processing system of claim 9, wherein the at least one valid payment mode includes multiple payment modes and to identify the savings based best offer the processor is to:
output a combination of the multiple payment modes to be used to pay for at least one product of the one or more products as the selected payment modes in the savings based best offer.

12. The AI-based payments processing system of claim 11, wherein to process the output of the mix and match model using the dynamic decision tree scoring model the processor is to:
select, using the mix and match model, at least one valid payment mode from the plurality of payment modes to be used for partial payment of the at least one product based on independent savings amount associated with the at least one valid payment mode;
generate a carry forward amount for remaining payment for the at least one product based on a minimum offer condition and maximum absolute discount available;
increase weightage of the at least one valid payment mode in response to generation of the carry forward amount;
obtain, using the dynamic decision tree scoring model, the paths that combine the at least one valid payment mode corresponding to each of the one or more products;
calculate a cumulative score for each of the paths by combining the independent savings amount with a path weightage; and
identify the at least one valid payment mode associated with one of the paths with a highest cumulative score from the cumulative scores as the selected payment modes in the savings based best offer.

13. The AI-based payments processing system of claim 1, wherein the processor is to:
execute dimensionality reduction process on training data for the user behavior model and the savings oriented model; and
train the user behavior model and the savings oriented model on the training data for identifying best offers.

14. A method of processing payments for a user's purchases comprising:
extracting data from an invoice including details of a user's purchases, wherein the data extracted from the invoice includes at least a listing of one or more products purchased by the user and corresponding prices of the one or more products;
retrieving user data pertaining to one or more payment modes associated with a user profile, wherein the one or more payment modes are used to pay for the user's purchase;
accessing offer data including offers of considerations for the one or more products corresponding to the one or more payment modes, the considerations to be received by the user in response to paying for the product with the corresponding payment mode of the one or more payment modes;
identifying a savings based best offer from the offers of considerations for at least one product of the one or more products, wherein the savings based best offer is determined by a savings oriented model based on the offer data, the savings oriented mode includes a mix and match model that outputs combinations of the one or more payment modes to be used to pay for the one or more products and the combinations are further processed by a dynamic decision tree structure model;
determining if the user profile has historical data related to prior user selections of offers and payment modes;
if the user profile includes the historical data:
identifying a user behavior based best offer from the offers of considerations for the at least one product of the one or more products, wherein the user behavior based best offer is determined by a user behavior model based on the historical data from the user profile and the offer data;
and
enabling payments for the user's purchase by selecting the payment modes based at least one of the user behavior based best offer and the savings based best offer.

15. The method of claim 14, wherein identifying the user behavior based best offer further comprises:
weighing each of the payment modes with corresponding weights proportional to a number of times the user selects the payment mode for purchase transactions.

16. The method of claim 15, wherein the user behavior model is based on K Nearest Neighbor (KNN) methodology.

17. The method of claim 14, wherein the savings oriented model is based on a mix and match model that employs data wrangling techniques.

18. The method of claim 14, wherein to enabling payments for the user's purchase further comprises:
determining if the user behavior based best offer is same as the savings based best offer in terms of the considerations and the corresponding payment modes;
weighing the user behavior based best offer higher than the savings based best offer if the user if the user behavior based best offer is not the same as the savings based best offer; and
presenting the user behavior based best offer and the savings based best offer for selection by the user.

19. A non-transitory processor-readable storage medium comprising machine-readable instructions that cause a processor to:
extract metadata from an invoice including details of a user's purchase, wherein the metadata extracted from the invoice includes at least a listing of one or more products purchased by the user and corresponding prices of the one or more products;
retrieve user data pertaining to one or more payment modes associated with a user profile, wherein the one or more payment modes are used to pay for the user's purchase;
access offer data including offers of considerations for the one or more products corresponding to the one or more payment modes, the considerations to be received by the user in response to paying for the product with the corresponding payment mode of the one or more payment modes;
identify a savings based best offer from the offers of considerations for at least one product of the one or more products, wherein the savings based best offer is identified by a savings oriented model that causes an output of a mix and match model to be processed by a dynamic decision tree structure model based on the offer data;
determine if the user profile has historical data related to prior user selections of offers and payment modes;
if the user profile includes the historical data:
identify a user behavior based best offer from the offers of considerations for the at least one product of the one or more products, wherein the user behavior based best offer is determined by a user behavior model based on the historical data from the user profile and the offer data;
and
enable payments for the user's purchase by selecting the payment modes based at least on one of the user behavior based best offer and the savings based best offer.

20. The non-transitory processor-readable storage medium of claim 19, further comprising instructions that cause the processor to:
provide a user interface with an auto pay option; and
automatically pay for the user's purchase with payment modes included in one of the savings based best offer and the user behavior based best offer in response to an activation of the auto pay option.
